(19) United States
(12) Patent Application Publication
(10) Pub. No.: US 2022/0340175 A1
(43) Pub. Date: Oct. 27, 2022

(54) AUTONOMOUS SYSTEM FOR A VEHICLE

(71) Applicant: Robert Bosch GmbH, Stuttgart (DE)

(72) Inventors: Alfred Strehle, Fellbach (DE); Thomas Schmidt, Bietigheim-Bissingen (DE)

(21) Appl. No.: 17/642,392

(22) PCT Filed: Aug. 10, 2020
(86) PCT No.: PCT/EP2020/072405

§ 371 Date: Mar. 11, 2022

(30) Foreign Application Priority Data
Oct. 2, 2019 (DE) 10 2019 215 190.6

(51) Int. Cl. B60W 60/00

(52) U.S. Cl. CPC B60W 60/00186; B60W 2520/10; B60W 2540/215; B60W 2520/125

(57) ABSTRACT

An autonomous system for a vehicle, having a control device. The autonomous system, when there is a functional impairment of the autonomous system and/or of a controlled vehicle component, is in a transition mode for at least a specified minimum transition time, in which mode the controlled component and/or at least one additional vehicle component of the traveling vehicle is controllable by the control device corresponding to a specified transition program. After the elapse of the minimum transition time, the autonomous system is in its transition mode until either a specified maximum transition time has elapsed or at least one current speed of the vehicle is below a specified maximum speed, there is a request by the driver for the acceleration of the vehicle, a current transverse acceleration of the vehicle is below a specified maximum transverse acceleration, and/or at least one vehicle stabilization controller of the vehicle is inactive.

### FIELD

The present invention relates to an autonomous system for a vehicle. The present invention also relates to a method for operating an autonomous system of a vehicle.

### BACKGROUND INFORMATION

From the related art, autonomous systems are available for relieving the operating burden on the driver during travel of the vehicle. For example, German Patent Application No. DE 10 2017 217 502 A1 describes a method and a device for automated parking on a parking space of a vehicle capable of autonomous driving.

### SUMMARY

The present invention provides an autonomous system for a vehicle and a method for operating an autonomous system of a vehicle.

The present invention provides possibilities for ensuring an advantageous transition of a traveling vehicle from a first operating mode of the vehicle, in which the vehicle is controlled at least partly by the autonomous system in its autonomous mode, to a second operating mode of the vehicle in which a driver has sole control of the vehicle. The possibilities provided by the present invention reliably ensure that the driver takes over a comparatively stable and relatively safe vehicle, and thus still has good driving comfort despite a probable functional impairment of the autonomous system and/or of at least one vehicle component controllable by the autonomous system. Moreover, the present invention improves the standard of safety of a vehicle that is making use of the present invention.

In an advantageous specific embodiment of the present invention, even after the elapsing of the minimum transition time the autonomous system is in its transition mode until either a current speed of the vehicle is below the specified maximum speed or the specified maximum transition time has elapsed. In this way, it can be ensured that the driver does not take over sole control of the vehicle until there is good stabilization of the vehicle, in particular good longitudinal stabilization of the vehicle, in its fallback level. This saves the driver from taking over sole control of the vehicle in a risky situation.

Alternatively, even after the elapsing of the minimum transition time the autonomous system can be in its transition mode until either the specified maximum transition time has elapsed or until there is a request by the driver for the acceleration of the vehicle, and a current transverse acceleration of the vehicle is below the specified maximum transverse acceleration and the at least one vehicle stabilization controller is inactive. A request for an acceleration of the vehicle by the driver as a rule indicates that the driver regards the current situation as unproblematic. A current transverse acceleration of the vehicle below the specified maximum transverse acceleration, and an inactive state of the at least one vehicle stabilization controller, also indicate that the vehicle is comparatively stable. Thus, the specific embodiment described here of the autonomous system also saves the driver from taking over sole control of the vehicle in a risky situation.

For example, at least one target speed of the travel of the vehicle, a target acceleration of the travel of the vehicle, a target deceleration of the travel of the vehicle, and/or a target travel direction of the travel of the vehicle can be autonomously definable as the at least one target variable by the control device of the autonomous system in its autonomous mode. The invention described here can thus be used for a multiplicity of autonomous systems of vehicles, such as for an autonomous/automatic speed regulation (ACC, Adaptive Cruise Control), an autonomous parking system, or an autonomous system for automatic/driverless travel of the vehicle.

As an advantageous development of the present invention, at least one activation signal can be capable of being issued to at least one warning device of the vehicle by the autonomous system in its transition mode. Using the specific embodiment described here of the autonomous system, an additional automatic system for activating the at least one warning device when there is at least one functional impairment of the autonomous system and/or of the at least one vehicle component controlled thereby can therefore be saved.

In a further advantageous specific embodiment of the present invention, after the elapsing of the maximum transition time the autonomous system is in an emergency braking mode in which the at least one, and/or at least one additional, vehicle component of the traveling vehicle is controllable by the control device in such a way that the vehicle can be brought to a standstill by the at least one controlled vehicle component. In a situation in which even during the maximum transition time the vehicle cannot be stabilized to such an extent that the driver can take over a comparatively stable and relatively safe vehicle, this still ensures at least a reliable bringing of the vehicle to a safe standstill.

The autonomous system can include the single vehicle component controllable by the autonomous system or at least one of the vehicle components controllable by the autonomous system. Alternatively, the autonomous system can however also be made up only of the control device by which the functions described above can be carried out.

Preferably, the autonomous system is designed at least as a brake system. In this case, the system can be used in many cases and for many applications in different types of vehicles/motor vehicles.

The advantages described above are also realized by carrying out a corresponding method for operating an autonomous system of the vehicle. It is expressly noted here that the method for operating an autonomous system of the vehicle can be developed according to the above-explained specific embodiments of the autonomous system of the present invention.

### BRIEF DESCRIPTION OF THE DRAWINGS

Further features and advantages of the present invention are explained in the following on the basis of the Figures.

FIG. 1 shows a schematic time sequence of a specific embodiment of the method for operating an autonomous system of the vehicle, in accordance with the present invention.

FIG. 2 shows a schematic representation of a specific embodiment of the autonomous system, in accordance with the present invention.

### DETAILED DESCRIPTION OF EXAMPLE EMBODIMENTS

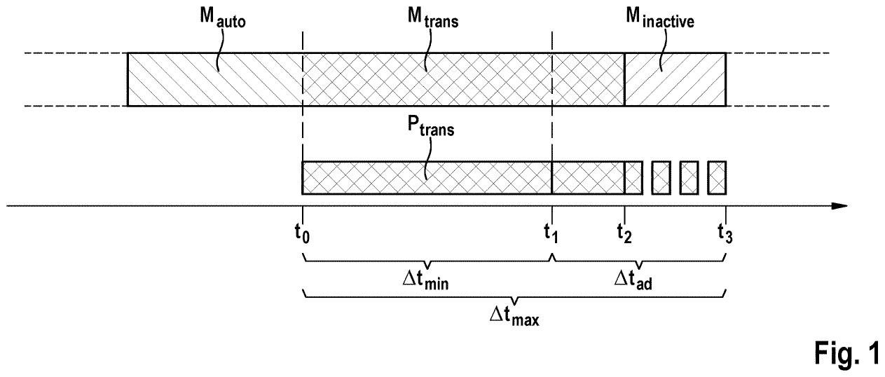

FIG. 1 shows a schematic time sequence of a specific embodiment of the method for operating an autonomous system of the vehicle.

The time sequence reproducing the specific embodiment described here of the method is indicated by a time axis t. Up to a time t₀, the autonomous system is operated in an autonomous mode Mₐᵤₜₒ. The autonomous mode Mₐᵤₜₒ is to be understood as an operating mode of the autonomous system in which at least one target variable of a trip of the vehicle is autonomously defined. This is to be understood as meaning that the system, in its autonomous mode Mₐᵤₜₒ, does not take into account any specification of the driver of the vehicle in the autonomous defining of the at least one target variable of the current travel of the vehicle. This can also be referred to as driverless defining of the at least one target variable of the current travel of the vehicle by the autonomous system in its autonomous mode Mₐᵤₜₒ. For example, the autonomous system in its autonomous mode Mₐᵤₜₒ can define the at least one target variable on the basis of at least one item of environmental information provided by at least one environmental monitoring device of the vehicle and/or by at least one vehicle-external environmental monitoring system. Optionally, at least one item of vehicle state information provided by at least one sensor system of the vehicle can also be taken into account in the defining of the at least one target variable by the autonomous system in its autonomous mode Mₐᵤₜₒ.

Moreover, in the autonomous mode Mₐᵤₜₒ at least one vehicle component of the traveling vehicle is autonomously controlled by the autonomous system corresponding to the at least one defined target variable. For example a target speed of the travel of the vehicle, a target acceleration of the travel of the vehicle, a target deceleration of the travel of the vehicle, and/or a target direction of travel of the travel of the vehicle can be defined as the at least one target variable of the current travel of the vehicle. The autonomous system in its autonomous mode Mₐᵤₜₒ controls the at least one vehicle component of the traveling vehicle in this case in such a way that an actual speed of the travel of the vehicle, an actual acceleration of the travel of the vehicle, an actual deceleration of the travel of the vehicle, and/or an actual direction of travel of the travel of the vehicle correspond to the at least one defined target variable. The at least one vehicle component controllable by the autonomous system in its autonomous mode Mₐᵤₜₒ can be understood as being any device of the vehicle by which (at least) its actual speed, its actual acceleration, its actual deceleration, and/or its actual direction of travel can be adjusted or controlled. The at least one vehicle component controllable by the autonomous system in its autonomous mode Mₐᵤₜₒ can be for example an engine of the vehicle, an electromechanical/motorized power brake booster upstream from a master brake cylinder of the vehicle, at least one pump motor of at least one pump of a hydraulic brake system of the vehicle, at least one piston-cylinder device (IPB, Integrated Power Brake) integrated in the hydraulic brake system of the vehicle, and/or a steering system of the vehicle. Using the function described above of the autonomous system in its autonomous mode Mₐᵤₜₒ, for example a fully autonomous/fully automatic driving of the vehicle (in particular driverless travel of the vehicle), a partly autonomous/partly automatic driving of the vehicle, an autonomous/automatic speed regulation of the vehicle (ACC, Adaptive Cruise Control), an autonomous/automatic travel direction regulation of the vehicle, and/or an autonomous/automatic parking of the vehicle can be brought about.

At time t₀ it is determined that there is at least one functional impairment of the autonomous system in its autonomous mode Mₐᵤₜₒ and/or of the at least one vehicle component controlled thereby. The presence of at least one functional impairment of the at least one controlled vehicle component can also be understood as the presence of at least one functional impairment of at least one sensor system of the respective vehicle component. In order to investigate whether there is at least one functional impairment of the autonomous system in its autonomous mode Mₐᵤₜₒ and/or of the at least one vehicle component controlled thereby, for example the at least one item of vehicle state information provided by a sensor system of the vehicle can be continuously evaluated by the autonomous system in its autonomous mode Mₐᵤₜₒ.

Starting from time t₀ (possibly with a negligible delay time), the autonomous system is operated in a transition mode Mₜᵣₐₙₛ for at least a specified minimum transition time Δtₘᵢₙ The autonomous system can in particular switch automatically to the transition mode Mₜᵣₐₙₛ starting from the determination that there is at least one functional impairment of the autonomous system in its autonomous mode Mₐᵤₜₒ and/or of the at least one vehicle component controlled thereby. The transition mode Mₜᵣₐₙₛ is to be understood as an operating mode of the autonomous system in which the at least one vehicle component and/or at least one additional vehicle component of the traveling vehicle is controlled corresponding to a specified transition program Pₜᵣₐₙₛ. Preferably, during the minimum transition time Δtₘᵢₙ, as transition program Pₜᵣₐₙₛ a “stabilization program” is carried out in such a way that the vehicle is comparatively stable after the elapsing of the minimum transition time Δtₘᵢₙ at a time t₁, and therefore the driver can be provided with a relatively stable vehicle in a comparatively safe driving situation. During the minimum transition time Δtₘᵢₙ, the autonomous system in its transition mode Mₜᵣₐₙₛ additionally autonomously defines at least the at least one target variable of the current travel of the vehicle according to the specified transition program Pₜᵣₐₙₛ, and controls the respective at least one vehicle component corresponding to the at least one autonomously defined target variable. Here, during the minimum transition time Δtₘᵢₙ, in the definition of the at least one target variable of the current travel of the vehicle the autonomous system in its transition mode Mₜᵣₐₙₛ ignores all actuations by the driver for the driver-induced specification of the at least one target variable. In this way, the driver can be prevented from taking over sole control of the vehicle too early, and therefore being overburdened by a current driving situation of the not-yet-stabilized vehicle.

Preferably, however, starting from time t₀ (possibly with a negligible delay time), during an activation of at least one warning device of the vehicle the driver is made aware of the presence of at least one functional impairment of the autonomous system and/or of the at least one controlled vehicle component. Through the activation of the at least one warning device, the driver can also be informed that the autonomous system is still only transitionally carrying out a partly or completely autonomous controlling of the travel of the vehicle. At least one warning light, at least one warning display, at least one warning sound emitter, and/or at least one voice output device can be activated as the at least one warning device of the vehicle.

However, after the elapsing of the minimum transition time Δtₘᵢₙ/starting from time t₁ the autonomous system is also operated in its transition mode Mₜᵣₐₙₛ until either a specified maximum transition time Δtₘₐₓ has elapsed or until a current speed of the vehicle is below a specified maximum speed, there is a request by the driver for the acceleration of the vehicle, a transverse acceleration of the vehicle is below a specified maximum transverse acceleration, and/or at least one vehicle stabilization controller of the vehicle is inactive. Optionally, the maximum speed can be specified to be so low that the current speed of the vehicle is below the specified maximum speed only when the vehicle is at a standstill. The at least one vehicle stabilization controller can for example be understood as an antilock brake system of the vehicle (ABS), a drive slippage control of the vehicle (TCS, Traction Control System), or an electronic stability program of the vehicle (VDC, Vehicle Dynamics Control).

For this reason, the autonomous system is in its transition mode Mₜᵣₐₙₛ at least for the minimum transition time Δtₘᵢₙ, the transition mode Mₜᵣₐₙₛ lasting at most for the maximum transition time Δtₘₐₓ. The method described here thus enables, even after the elapsing of the minimum transition time Δtₘᵢₙ/starting from time t₁, a prolongation, adapted to the needs of the situation, of the transition mode Mₜᵣₐₙₛ of the autonomous system by a maximum additional time Δt_{ad}, in order to ensure that the vehicle is stabilized when the transition mode Mₜᵣₐₙₛ ends and the control of the vehicle exclusively by the driver begins. The maximum additional time Δt_{ad} corresponds to a difference between the maximum transition time Δtₘₐₓ and the minimum transition time Δtₘᵢₙ The actual duration of the respective transition mode Mₜᵣₐₙₛ which is between the maximum transition time Δtₘₐₓ and the minimum transition time Δtₘᵢₙ, can be varied according to the needs of the situation. A stabilized state of the vehicle can be assumed when the speed of the vehicle is below the specified maximum speed, a transverse acceleration of the vehicle is below the specified maximum transverse acceleration, and/or the at least one vehicle stabilization controller is inactive. A stabilized state of the vehicle can also be assumed if there is a request by the driver for the acceleration of the vehicle, because as a rule a driver will request an acceleration of the vehicle only if the vehicle is stabilized.

Preferably, even after the elapsing of the minimum transition time Δtₘᵢₙ/starting from time t₁ the autonomous system is operated in its transition mode Mₜᵣₐₙₛ until either a current speed of the vehicle is below the specified maximum speed or until the specified maximum transition time Δtₘₐₓ has elapsed. In this way, it can be ensured that the driver does not take over sole control of the vehicle until a good stabilization of the vehicle, in particular a good longitudinal stabilization of the vehicle, is ensured.

It is also advantageous if, even after the elapsing of the minimum transition time Δtₘᵢₙ/starting from time t₁, the autonomous system is operated in its transition mode Mₜᵣₐₙₛ until either the specified maximum transition time Δtₘₐₓ has elapsed or until there is a request by the driver for the acceleration of the vehicle and a current transverse acceleration of the vehicle is below the specified maximum transverse acceleration and the at least one vehicle stabilization controller is inactive. A request for an acceleration of the vehicle by the driver with the simultaneous presence of a current transverse acceleration of the vehicle below the specified maximum transverse acceleration and a simultaneous inactive state of the at least one vehicle stabilization controller indicates that the vehicle is relatively stable. In this way, the driver is saved from having to take over sole control of the vehicle in a comparatively risky situation.

In the example of FIG. 1, the driver does not request an acceleration of the vehicle until a time t₂ (later than time but still before the elapsing of maximum transition time Δtₘₐₓ). Therefore, in this case the transition mode Mₜᵣₐₙₛ of the autonomous system is ended at time t₂ (possibly with a negligible delay time), although the minimum transition time Δtₘᵢₙ has already elapsed at time t₁ and the transition mode Mₜᵣₐₙₛ would be capable of being continued until a time t₃. Starting from time t₂, the vehicle is thus controlled solely by the driver. Therefore, starting from time t₂ the autonomous system is in an inactive mode M_{inactive}.

However, as soon as the maximum transition time Δtₘₐₓ elapses without, during the maximum additional time Δt_{ad}, determination of a current speed of the vehicle below a specified maximum speed, a request by the driver for the acceleration of the vehicle, a transverse acceleration of the vehicle below a specified maximum transverse acceleration, and/or an inactive state of the at least one vehicle stabilization controller, then preferably, after elapsing of the maximum transition time Δtₘₐₓ/starting from time t₃ (possibly with a negligible delay time), the autonomous system preferably goes into an emergency braking mode (not shown) in which the autonomous system controls the at least one, and/or at least one additional, vehicle component of the traveling vehicle in such a way that the vehicle is brought to a standstill by the at least one controlled vehicle component. If, despite the prolongation of the transition mode Mₜᵣₐₙₛ of the autonomous system by the maximum additional time Δt_{ad}, stabilization of the vehicle is not achieved in this way, then the vehicle can nonetheless safely be brought to a standstill. In this way, a high standard of safety is ensured even in such a situation.

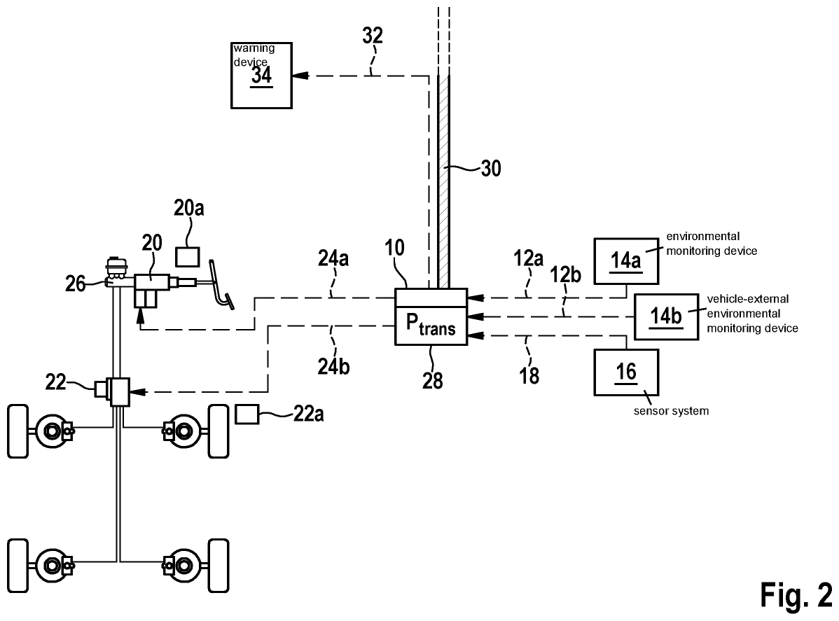

FIG. 2 shows a schematic representation of a specific embodiment of the autonomous system.

It is to be noted that the applicability of the autonomous system described below is not limited to a particular vehicle type/motor vehicle type of a vehicle/motor vehicle equipped therewith.

The autonomous system of FIG. 2 includes a control device 10 that is designed in such a way that, using control device 10 of the autonomous system in its autonomous mode Mₐᵤₜₒ, at least one target variable of a travel of the vehicle is autonomously definable/defined. The definition of the at least one target variable of the current travel of the vehicle by control device 10 takes place autonomously, for example taking into account at least one item of environmental information 12a and 12b outputted to control device 10 by at least one environmental monitoring device 14a of the vehicle and/or at least one vehicle-external environmental monitoring system 14b, and/or taking into account at least one item of vehicle state information 18 provided by a sensor system 16 of the vehicle. Preferably, control device 10 of the autonomous system in its autonomous mode Mₐᵤₜₒ is designed to ignore any specification by the driver during the autonomous mode Mₐᵤₜₒ, even when there is a specification by the driver relating to the at least one target variable.

Control device 10 of the autonomous system in its autonomous mode Mₐᵤₜₒ is also designed to autonomously control at least one vehicle component 20 and 22 of the vehicle using at least one control signal 24a and 24b corresponding to the at least one defined target variable. In this way, using control device 10 for example a fully autonomous/fully automatic driving of the vehicle (in particular driverless travel of the vehicle), partly autonomous/partly automatic driving of the vehicle, autonomous/automatic speed controlling of the vehicle (ACC, Adaptive Cruise Control), autonomous/automatic travel direction controlling of the vehicle, and/or autonomous/automatic parking of the vehicle can be brought about.

The vehicle component 20 and 22 controllable by the at least one control signal 24a and 24b when the autonomous system is in its autonomous mode Mₐᵤₜₒ can for example be at least one brake actuator system 20 and 22. In the example of FIG. 2, as an example, an electromechanical/motorized brake booster 20, upstream from a master brake cylinder 26, and a motorized hydraulic device 22 can be controllable as the at least one controllable vehicle component 20 and 22. The motorized hydraulic device 22 can be understood as at least one pump motor of at least one hydraulic pump of a hydraulic brake system of the vehicle and/or at least one motorized piston-cylinder device (IPD, Integrated Power Brake) integrated into the hydraulic brake system of the vehicle. However, the design shown graphically in FIG. 2 of the at least one vehicle component 20 and 22 is to be interpreted only as an example.

Optionally, as the at least one brake actuator system 20 and 22, a primary brake actuator system 20 and a secondary brake actuator system 22 can be controllable by control device 10 in such a way that, during the autonomous mode Mₐᵤₜₒ of the autonomous system, primary brake actuator system 20 is primarily used to brake the vehicle, and secondary brake actuator system 22 is used only to support primary brake actuator system 20. Preferably, electromechanical/motorized power brake booster 20 is used as primary brake actuator system 20 and motorized hydraulic device 22 is used as secondary brake actuator system 22, because such a division of tasks ensures a noise-optimized braking of the vehicle.

When there is a received or self-defined item of information relating to the presence of at least one functional impairment of the autonomous system in its autonomous mode Mₐᵤₜₒ, and/or of the at least one controlled vehicle component 20 and 22, the autonomous system can be brought from its autonomous mode Mₐᵤₜₒ into a transition mode Mₜᵣₐₙₛ. The presence of at least one functional impairment of the autonomous system and/or of the at least one vehicle component 20 and 22 controlled therewith can for example be a fault in the primary brake actuator system 20, a fault in a sensor system 20a of primary brake actuator system 20, a fault in secondary brake actuator system 22, and/or a fault in a sensor system 22a of secondary brake actuator system 22. As faults in a sensor system 20a and 22a of primary brake actuator system 20 and/or in secondary brake actuator system 22, in particular a fault in a rotational speed sensor of a wheel of the vehicle can also introduce the bringing of the autonomous system from its autonomous mode Mₐᵤₜₒ into the transition mode Mₜᵣₐₙₛ.

The autonomous system is in transition mode Mₜᵣₐₙₛ at least for a specified minimum transition time, in which mode its control device 10 controls the at least one vehicle component 20 and 22 and/or at least one further vehicle component of the traveling vehicle corresponding to a specified transition program Pₜᵣₐₙₛ. Transition program Pₜᵣₐₙₛ can be stored on a storage unit 28 of control device 10. Preferably, during the minimum transition time Δtₘᵢₙ, as transition program Pₜᵣₐₙₛ a “stabilization program” is carried out by control device 10 in such a way that after the elapsing of the minimum transition time Δtₘᵢₙ the vehicle is comparatively stable. As “stabilization program,” in particular a fallback level longitudinal stabilization can be carried out by control device 10.

In addition, even after the elapsing of the minimum transition time, the autonomous system is in its transition mode Mₜᵣₐₙₛ until either a specified maximum transition time has elapsed or until at least one current speed of the vehicle is below a specified maximum speed, there is a request by the driver for the acceleration of the vehicle, a current transverse acceleration of the vehicle is below a specified maximum transverse acceleration, and/or at least one vehicle stabilization controller of the vehicle is inactive. As needed, the transition mode Mₜᵣₐₙₛ can thus last until the vehicle is stabilized and the driver can “take over” the vehicle without risk, or until the specified maximum transition time has elapsed. Thus, when the driver takes over the vehicle, as a rule the driver will not have any problems with the safe continuation of the already-begun travel of the vehicle.

Control device 10 can for example be connected to a (schematically shown) vehicle bus 30 in such a way that a current speed of the vehicle, a signal relating to a request by the driver for the acceleration of the vehicle, a current transverse acceleration of the vehicle, and/or a respective operating state of the at least one vehicle stabilization controller of the vehicle can be provided to control device 10. Optionally, control device 10 can also be connected “directly” to a speed sensor in order to measure a current speed of the vehicle, to a sensor for recognizing a request by the driver for the acceleration of the vehicle, to a transverse acceleration sensor for measuring a current transverse acceleration of the vehicle, to the at least one vehicle stabilization controller of the vehicle, and/or to an electronics unit for estimating a current speed of the vehicle and/or a current transverse acceleration of the vehicle.

At least one activation signal 32 can also be capable of being issued to at least one warning device 34 of the vehicle by the autonomous system in its transition mode, in particular by its control device 10. In this way, the driver can be informed that the autonomous system is now only transitionally carrying out a partly or fully autonomous controlling of the travel of the vehicle.

As an advantageous development, after the elapsing of the maximum transition time the autonomous mode can be in an emergency braking mode in which the at least one, and/or at least one additional, vehicle component 20 and 22 of the traveling vehicle can be controllable by control device 10 in such a way that the vehicle can be brought to a standstill by the at least one controlled vehicle component 20 and 22. If, after the recognition of the presence of at least one functional impairment of the electromechanical/motorized power brake booster 20, stabilization of the vehicle is not brought about within the maximum transition time, then the vehicle can still be reliably braked through corresponding controlling of motorized hydraulic device 22, by control device 10 of the autonomous system in the emergency braking mode.

1-11. (canceled)

12. An autonomous system for a vehicle, comprising:
a control device configured in such a way that, using the control device of the autonomous system in an autonomous mode, at least one target variable of a trip of the vehicle is autonomously defined, and at least one vehicle component of the vehicle is autonomously controlled corresponding to the at least one defined target variable;
wherein the autonomous system, when there is a received or self-defined item of information relating to a presence of at least one functional impairment of the autonomous system in the autonomous mode and/or of the at least one controlled vehicle component, is operated in a transition mode for at least a specified minimum transition time, and wherein, in which transition mode, the at least one controlled vehicle component and/or at least one additional vehicle component of the traveling vehicle, is controlled by the control device corresponding to a specified transition program; and
wherein after an elapsing of the minimum transition time, the autonomous system is operated in the transition mode either: (i) until a specified maximum transition time has elapsed, or (ii) until at least one current speed of the vehicle is below a specified maximum speed, and/or there is a request by a driver for an acceleration of the vehicle, and/or a current transverse acceleration of the vehicle is below a specified maximum transverse acceleration, and/or at least one vehicle stabilization controller of the vehicle is inactive.

13. The autonomous system as recited in claim 12, wherein the autonomous system is also operated in the transition mode after the elapsing of the minimum transition time until either a current speed of the vehicle is below the specified maximum speed or the specified maximum transition time has elapsed.

14. The autonomous system as recited in claim 12, wherein the autonomous system is operated in the transition mode after the elapsing of the minimum transition time until either the specified maximum transition time has elapsed or until there is a request by the driver for the acceleration of the vehicle and a current transverse acceleration of the vehicle is below the specified maximum transverse acceleration and the at least one vehicle stabilization controller is inactive.

15. The autonomous system as recited in claim 12, wherein at least one target variable of a travel of the vehicle, and/or a target acceleration of the travel of the vehicle, and/or a target deceleration of the travel of the vehicle, and/or a target travel direction of the travel of the vehicle, is autonomously defined as the at least one target variable by the control device of the autonomous system in the autonomous mode.

16. The autonomous system as recited in claim 12, wherein at least one activation signal is capable of being issued to at least one warning device of the vehicle by the autonomous system in the transition mode.

17. The autonomous system as recited in claim 12, wherein the autonomous system is operated in an emergency braking mode after the elapsing of the maximum transition time, in which emergency braking mode the at least one and/or at least one additional vehicle component of the traveling vehicle is controllable by the control device in such a way that the vehicle can be brought to a standstill by the at least one controlled vehicle component.

18. The autonomous system as recited in claim 12, wherein the autonomous system includes the vehicle component controllable by the autonomous system or at least one of the vehicle components controllable by the autonomous system.

19. The autonomous system as recited in claim 18, wherein the autonomous system is configured at least as a brake system.

20. A method for operating an autonomous system of a vehicle, comprising the following steps:
operating the autonomous system in an autonomous mode in which at least one target variable of a trip of the vehicle is defined autonomously and at least one vehicle component of the traveling vehicle is autonomously controlled corresponding to the at least one defined target variable; and
operating, when there is at least one functional impairment of the autonomous system in its autonomous mode and/or of the at least one controlled vehicle component, the autonomous system in a transition mode for at least a specified minimum transition time, in which transition mode the at least one and/or at least one additional vehicle component of the traveling vehicle is controlled corresponding to a specified transition program;
wherein after the elapsing of the minimum transition time, the autonomous system is operated in the transition mode either: (i) until a specified maximum transition time has elapsed, or (ii) until at least one current speed of the vehicle is below a specified maximum speed, and/or there is a request by a driver for an acceleration of the vehicle, and/or a current transverse acceleration of the vehicle is below a specified maximum transverse acceleration, and/or at least one vehicle stabilization controller of the vehicle is inactive.

21. The method as recited in claim 20, wherein the autonomous system is operated, after the elapsing of the minimum transition time, in the transition mode until either a current speed of the vehicle is below the specified maximum speed or the specified maximum transition time has elapsed.

22. The method as recited in claim 20, wherein the autonomous system is operated, after the elapsing of the minimum transition time, in the transition mode either (i) until the specified maximum transition time has elapsed or (ii) until there is a request by the driver for the acceleration of the vehicle and a current transverse acceleration of the vehicle is below the specified maximum transverse acceleration and the at least one vehicle stabilization controller is inactive.
